(19) United States
(12) Patent Application Publication
(10) Pub. No.: US 2023/0403093 A1
(43) Pub. Date: Dec. 14, 2023

(54) SYSTEMS AND METHODS FOR AVOIDING POTENTIAL BROADCAST INTERFERENCE BETWEEN RADIO FREQUENCY TRANSMISSIONS

(71) Applicant: Ademco Inc., Golden Valley, MN (US)

(72) Inventors: Nagaraj Chickmagalur LAKSHMINARAYAN, Bangalore, Karnataka (IN); Arun Handanakere SHESHAGIRI, Bangalore, Karnataka (IN)

(21) Appl. No.: 18/252,090

(22) PCT Filed: Nov. 16, 2021
(86) PCT No.: PCT/US2021/059499

§ 371 Date: May 8, 2023

(30) Foreign Application Priority Data
Nov. 24, 2020 (IN) 202041051016

(51) Int. Cl. H04J 11/00; H04W 56/00

(52) U.S. Cl. CPC H04J 11/005; H04W 56/001; H04W 56/003

(57) ABSTRACT

Systems and methods for avoiding potential broadcast interference between radio frequency transmissions in connected systems are provided. Such systems and methods can include determining that a first central hub device and a second central hub device are located within a potential broadcast interference range of each other and, responsive thereto, transmitting a first beacon offset sequence time to the first central hub device and a second beacon offset sequence time to the second central hub device. The first beacon offset sequence time can modify a base time at which the first central hub device is scheduled to broadcast a first TDMA beacon, and the second beacon offset sequence time can modify the base time at which the second central hub device is scheduled to broadcast a second TDMA beacon such that the second TDMA beacon can fail to overlap any portion of the first TDMA beacon.

### RELATED APPLICATION

This application is based upon and claims priority from Indian Provisional Patent Application No. 202041051016, filed on Nov. 24, 2020.

### FIELD

The present invention relates generally to radio frequency transmissions in connected systems. More particularly, the present invention relates to systems and methods for avoiding potential broadcast interference between the radio frequency transmissions in the connected systems.

### BACKGROUND

Reduced costs and improved abilities of wireless communication technology has led to widespread use of wireless communication in connected home systems, such as smart home systems and security systems. However, this increased usage has led to broadcast interference problems for independent systems operating in close proximity to each other. In particular, this problem is evident in residential locations that are located physically close to one another, such as apartment complexes and town homes, where radio frequency communications are more likely to overlap and cause interference.

In view of the above, there is a need and an opportunity for improved systems and methods.

### BRIEF DESCRIPTION OF THE DRAWINGS

FIG. 1 is a block diagram of a connected system in accordance with disclosed embodiments;

FIG. 2 is a flow diagram of a method in accordance with disclosed embodiments; and

FIG. 3 is a flow diagram of a method in accordance with disclosed embodiments.

### DETAILED DESCRIPTION

While this invention is susceptible of an embodiment in many different forms, specific embodiments thereof will be described herein in detail with the understanding that the present disclosure is to be considered as an exemplification of the principles of the invention. It is not intended to limit the invention to the specific illustrated embodiments.

Embodiments of the claimed invention can include systems and methods for avoiding potential broadcast interference between radio frequency transmissions in connected systems. For example, in embodiments that include two of the connected systems, a first of the connected systems can include a first central hub device that can manage and communicate with a first plurality of peripheral devices at a first location, and a second of the connected systems can include a second central hub device that can manage and communicate with a second plurality of peripheral devices at a second location.

Various embodiments for the first central hub device, the second central hub device, the first plurality of peripheral devices, and the second plurality of peripheral devices are contemplated. For example, in some embodiments, the first central hub device and the second central hub device can include control panels or security panels of security systems, and the first plurality of peripheral devices and the second plurality of peripheral devices can include security devices in communication with the control panels or the security panels, such as door open sensors, glass break sensors, motion sensors, and other security devices as known in the art. Additionally or alternatively, in some embodiments, the first central hub device and the second central hub device can include communication hub devices of smart home systems, such as dedicated voice assistant devices, thermostats, refrigerators, televisions, personal computers, and the like, and the first plurality of peripheral devices and the second plurality of peripheral devices can include connected smart home devices in communication with the communication hub devices.

In some embodiments, the first central hub device and the second central hub device can connect to and communicate with a cloud server via a wide area network, such as the internet. As such, in some embodiments, the cloud server can determine whether the first central hub device and the second central hub device are located within a potential broadcast interference range of each other, and when the first central hub device and the second central hub device are located within the potential broadcast interference range of each other, the cloud server can generate and transmit a first beacon offset sequence time to the first central hub device and generate and transmit a second beacon offset sequence time to the second central hub device. In some embodiments, the first beacon offset sequence time can modify a base time at which the first central hub device is scheduled to broadcast a first time division multiple access (TDMA) beacon to the first plurality of peripheral devices, and the second beacon offset sequence time can modify the base time at which the second central hub device is scheduled to broadcast a second TDMA beacon to the second plurality of peripheral devices such that the second TDMA beacon can fail to overlap any portion of the first TDMA beacon.

In some embodiments, the cloud server can transmit the base time to the first central hub device and the second central hub device so that the base time is synchronized between the first central hub device and the second central hub device. Additionally or alternatively, in some embodiments, the first central hub device and the second central hub device can synchronize the base time to a standard time measurement, such as an atomic clock or the like, via the internet.

In some embodiments, the first central hub device and the second central hub device can be configured to broadcast the first TDMA beacon and the second TDMA beacon, respectively, in a common channel. Alternatively, in some embodiments, the first central hub device can be configured to broadcast the first TDMA beacon in a first channel, and the second central hub device can be configured to broadcast the second TDMA beacon in a second channel that is different than the first channel.

In some embodiments, the cloud server can receive first location data identifying the first location and receive second location data identifying the second location. Then, the cloud server can use the first location data and the second location data to determine whether the first central hub device and the second central hub device are located within the potential broadcast interference range of each other.

Additionally or alternatively, in some embodiments the cloud server can store a plurality of location data sets for a plurality of central hub devices in a database. In these embodiments, when a new one of the plurality of central hub devices is initially set up and activated at a new location, the new one of the plurality of central hub devices or a user device associated therewith can transmit the new location to the cloud server, and the cloud server can search the database for any potentially interfering ones of the plurality of central hub devices with a respective location that is within the potential broadcast interference range of the new one of the plurality of central hub devices. If any potentially interfering ones of the plurality of central hub devices are identified, then the cloud server can generate and transmit thereto a respective beacon offset sequence time for the new one of the plurality of central hub devices and each of the potentially interfering ones of the plurality of central hub devices. After receiving the respective beacon offset sequence time, the new one of the plurality of central hub devices and each of the potentially interfering ones of the plurality of central hub devices can modify the base time at which that one of the plurality of central hub devices is scheduled to broadcast a respective TDMA beacon to avoid overlapping with the respective TDMA beacon broadcast by the new one of the plurality of central hub devices and/or other ones of the potentially interfering ones of the plurality of central hub devices.

For example, in some embodiments, when the first central hub device is initially set up and activated, the cloud server can receive the first location data and can search the database for any potentially interfering ones of the plurality of central hub devices. In some embodiments, the cloud server can compare the second location data as stored in the database to the first location data as received, identify the first location as within the potential broadcast interference range of the second location, and responsive thereto, identify the second central hub device as a potentially interfering one of the plurality of central hub devices. Then, the cloud server can generate the first beacon offset sequence time and the second beacon offset sequence time, transmit the first beacon offset sequence time to the first central hub device, and transmit the second beacon offset sequence time to the second central hub device as described herein.

In some embodiments, the cloud server can store the first beacon offset sequence time, the second beacon offset sequence time, and/or the respective beacon offset sequence time for the new one of the plurality of central hub devices and/or each of the potentially interfering ones of the plurality of central hub devices in the database after generation and/or initial transmission thereof for later use and/or future transmission thereof. For example, after the second beacon offset sequence time is generated and/or transmitted to the second central hub device, the second beacon offset sequence time can be stored in the database. Later, when the cloud server identifies the second central hub device as being located within the potential broadcast interference range of the first central hub device, the cloud server can recall and transmit the second beacon offset sequence time from the database without regeneration or modification thereof and use the second beacon offset sequence time to generate the first beacon offset sequence time for transmission to the first central hub device such that, when the first central hub device uses the first beacon offset sequence time to broadcast the first TDMA beacon, the first TDMA beacon can fail to overlap any portion of the second TDMA beacon broadcast by the second central hub device.

Various embodiments for the first location data and the second location data are contemplated. For example, in some embodiments, the first location data can include first GPS data identifying the first location, and the second location data can include second GPS data identifying the second location. In these embodiments, the cloud server can determine that the first central hub device and the second central hub device are located within the potential broadcast interference range of each other when the first GPS data and the second GPS data indicate that the first central hub device is within a predetermined range of the second central hub device.

Additionally or alternatively, in some embodiments the first location data can include a first text string, and the second location data can include a second text string. For example, in some embodiments, the first text string can include a first street address of the first location, and the second text string can include a second street address of the second location. In these embodiments, the cloud server can determine that the first central hub device and the second central hub device are located within the potential broadcast interference range of each other when at least a portion of the first text string matches the second text string, such as when two apartments in one building share the same street address.

Various embodiments for receiving the first location data and the second location data are also contemplated. For example, in some embodiments, the cloud server can receive the first location data from the first central hub device and receive the second location data from the second central hub device. Alternatively, in some embodiments, the cloud server can receive the first location data and the second location data from a common user device associated with both the first central hub device and the second central hub device. For example, in some embodiments, the common user device can be associated with an installer that initially configured both the first central hub device and the second central hub device. However, in some embodiments, the cloud server can receive the first location data from a first user device associated with the first central hub device (e.g. a user device of a user of the first central hub device) and receive the second location data from a second user device associated with the second central hub device (e.g. a user device of a user of the second central hub device). In any embodiment in which the cloud server receives any location data from any user device, that location data can include location identifying information that can be automatically generated by that user device and/or received via user input at that user device.

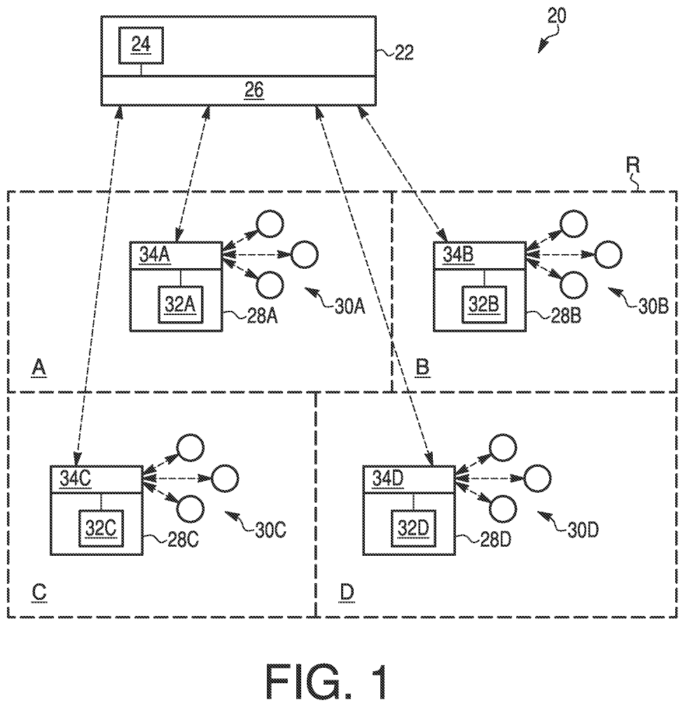

FIG. 1 is a block diagram of a system 20 in accordance with disclosed embodiments. As seen in FIG. 1, in some embodiments, the system 20 can include a cloud server 22, which can include a processor 24 and a transceiver 26, and central hub devices 28A, 28B, 28C, and 28D that can manage and communicate with a plurality of peripheral devices 30A, 30B, 30C, and 30D, respectively. As also seen in FIG. 1, in some embodiments, each of the central hub devices 28A, 28B, 28C, and 28D can include a respective processor 32A, 32B, 32C, and 32D and a respective transceiver 34A, 34B, 34C, and 34D that can communicate with the cloud server 28 and the plurality of peripheral devices 30A, 30B, 30C, and 30D, respectively.

Although the system 20 of FIG. 1 is shown with four central hub devices 28A, 28B, 28C, and 28D, it is to be understood that embodiments disclosed herein are not so limited. Instead, systems and methods disclosed herein can include two, three, four, or any number N of central hub devices as would be understood by one of ordinary skill in the art.

As seen in FIG. 1, in some embodiments, the central hub devices 28A, 28B, 28C, and 28D can be located in and/or associated with locations A, B, C, and D, respectively, that are located in a larger region R. For example, locations A, B, C, and D can represent apartment units in an apartment building R. In some embodiments, each of the locations A, B, C, and D can be within a broadcast interference range of each other, and in some embodiments, the cloud server 22 can be remote from the region R.

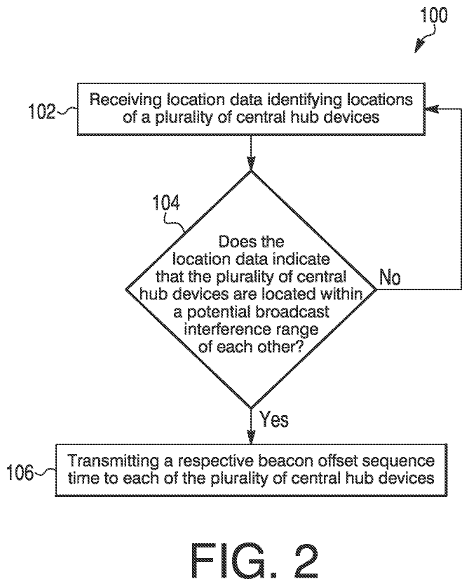

FIG. 2 is flow diagram of a method 100 according to disclosed embodiments. As seen in FIG. 2, the method 100 can include the cloud server 22 receiving, via the transceiver 26, location data identifying the locations A, B, C, and D of the central hub devices 28A, 28B, 28C, and 28D, as in 102. Then, the method 100 can include the processor 24 determining whether the location data indicates that any of the central hub devices 28A, 28B, 28C, and 28D are located within the potential broadcast interference range of each other, as in 104. If not, then the method 100 can include continuing to receive the location data identifying the locations A, B, C, and D of the central hub devices 28A, 28B, 28C, and 28D and/or other central hub devices, as in 102. However, when the location data indicates that any of the central hub devices 28A, 28B, 28C, and 28D are located within the potential broadcast interference range of each other, the method 100 can include the processor 24 generating and the transceiver 26 transmitting a respective beacon offset sequence time to each of the central hub devices 28A, 28B, 28C, and 28D within the potential broadcast interference range of each other, as in 106.

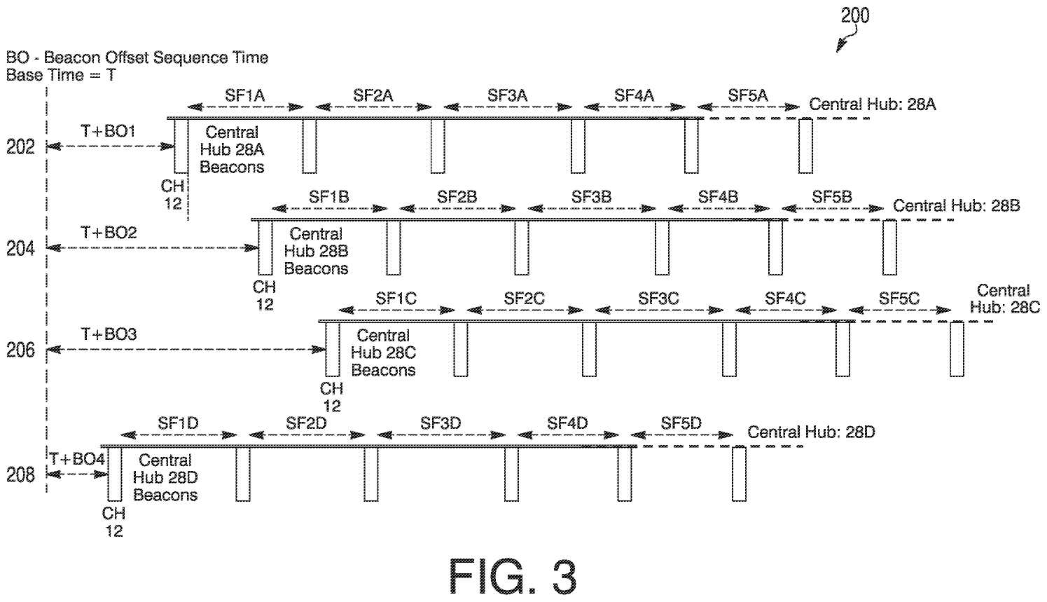

FIG. 3 is flow diagram of a method 200 according to disclosed embodiments. As seen in FIG. 3, when each of the central hub devices 28A, 28B, 28C, and 28D receives its respective beacon offset sequence time from the cloud server 22, the method 200 can include each of the central hub devices 28A, 28B, 28C, and 28D broadcasting a respective TDMA beacon in a common channel 12 at a respective time that is determined by modifying a base time T by the respective beacon offset sequence time for that one of the central hub devices 28A, 28B, 28C, and 28D such that the respective TDMA beacon broadcast by each of the central hub devices 28A, 28B, 28C, and 28D fails to overlap the respective TDMA beacon broadcast by another of the central hub devices 28A, 28B, 28C, and 28D. In particular, the method 200 can include (1) the central hub device 28A beginning to broadcast its respective TDMA beacon at a first scheduled broadcast time equal to a base time T plus a first beacon offset sequence time BO1, as in 202, (2) the central hub device 28B beginning to broadcast its respective TDMA beacon at a second scheduled broadcast time equal to the base time T plus a second beacon offset frequency time BO2, as in 204, (3) the central hub device 28C beginning to broadcast its respective TDMA beacon at a third scheduled broadcast time equal to the base time T plus a third beacon offset frequency time BO3, as in 206, and (4) the central hub device 28D beginning to broadcast its respective TDMA beacon at a fourth scheduled broadcast time equal to the base time T plus a fourth beacon offset frequency time BO4, as in 204.

Although a few embodiments have been described in detail above, other modifications are possible. For example, the logic flows described above do not require the particular order described or sequential order to achieve desirable results. Other steps may be provided, steps may be eliminated from the described flows, and other components may be added to or removed from the described systems. Other embodiments may be within the scope of the invention.

From the foregoing, it will be observed that numerous variations and modifications may be effected without departing from the spirit and scope of the invention. It is to be understood that no limitation with respect to the specific system or method described herein is intended or should be inferred. It is, of course, intended to cover all such modifications as fall within the spirit and scope of the invention.

What is claimed is:

1. A method comprising:
determining whether a first central hub device and a second central hub device are located within a potential broadcast interference range of each other; and
when the first central hub device and the second central hub device are located within the potential broadcast interference range of each other, transmitting a first beacon offset sequence time to the first central hub device and transmitting a second beacon offset sequence time to the second central hub device,
wherein the first beacon offset sequence time modifies a base time at which the first central hub device is scheduled to broadcast a first TDMA beacon, and
wherein the second beacon offset sequence time modifies the base time at which the second central hub device is scheduled to broadcast a second TDMA beacon such that the second TDMA beacon fails to overlap any portion of the first TDMA beacon.

2. The method of claim 1 further comprising:
receiving first location data identifying the first location;
receiving second location data identifying the second location; and
using the first location data and the second location data to determine whether the first central hub device and the second central hub device are located within the potential broadcast interference range of each other.

3. The method of claim 2 further comprising:
receiving the first location data from the first central hub device; and
receiving the second location data from the second central hub device.

4. The method of claim 2 further comprising:
receiving the first location data and the second location data from a user device associated with both the first central hub device and the second central hub device.

5. The method of claim 2 further comprising:
receiving the first location data from a first user device associated with the first central hub device; and
receiving the second location data from a second user device associated with the second central hub device.

6. The method of claim 2 wherein the first location data includes first GPS data identifying the first location, and wherein the second location data include second GPS data identifying the second location.

7. The method of claim 2 further comprising:
determining that the first central hub device and the second central hub device are located within the potential broadcast interference range of each other when the first location data and the second location data indicate that the first central hub device is within a predetermined range of the second central hub device.

8. The method of claim 2 further comprising:
determining that the first central hub device and the second central hub device are located within the potential broadcast interference range of each other when at least a portion of a first text string that includes the first location data matches a second text string that includes the second location data.

9. The method of claim 1 wherein further comprising:
transmitting the base time to the first central hub device and the second central hub device.

10. A system comprising:
a transceiver; and
a programmable processor that determines whether a first central hub device and a second central hub device are located within a potential broadcast interference range of each other,
wherein, when the programmable processor determines that the first central hub device and the second central hub device are located within the potential broadcast interference range of each other, the programmable processor directs the transceiver to transmit a first beacon offset sequence time to the first central hub device and transmit a second beacon offset sequence time to the second central hub device,
wherein the first beacon offset sequence time modifies a base time at which the first central hub device is scheduled to broadcast a first TDMA beacon, and
wherein the second beacon offset sequence time modifies the base time at which the second central hub device is scheduled to broadcast a second TDMA beacon such that the second TDMA beacon fails to overlap any portion of the first TDMA beacon.

11. The system of claim 10 wherein the transceiver receives first location data identifying a first location of the first central hub device and receives second location data identifying a second location of the second central hub device, and wherein the programmable processor uses the first location data and the second location data to determine whether the first central hub device and the second central hub device are located within the potential broadcast interference range of each other.

12. The system of claim 11 wherein the first location data includes first GPS data identifying the first location, and wherein the second location data include second GPS data identifying the second location.

13. The system of claim 11 wherein the programmable processor determines that the first central hub device and the second central hub device are located within the potential broadcast interference range of each other when the first location data and the second location data indicate that the first central hub device is within a predetermined range of the second central hub device.

14. The system of claim 11 wherein the first location data includes a first text string and the second location data include a second text string, and wherein the programmable processor determines that the first central hub device and the second central hub device are located within the potential broadcast interference range of each other when at least a portion of the first text string matches the second text string.

15. The system of claim 10 wherein the programmable processor directs the transceiver to transmit the base time to the first central hub device and the second central hub device.

16. A system comprising:
a first transceiver; and
a first programmable processor that manages a plurality of peripheral devices at a location,
wherein, when the first transceiver is within a potential broadcast interference range of a second transceiver controlled by a second programmable processor, the first transceiver receives a beacon offset sequence time from a cloud server, and
wherein the first programmable processor directs the first transceiver to broadcast a first TDMA beacon to the plurality of peripheral devices at a base time modified by the beacon offset sequence time such that the first TDMA beacon fails to overlap any portion of a second TDMA beacon broadcast by the second transceiver.

17. The system of claim 16 wherein the first transceiver broadcasts the first TDMA beacon in a common channel in which the second transceiver broadcasts the second TDMA beacon.

18. The system of claim 16 further comprising:
a GPS device that transmits GPS coordinates of the location to the cloud server for use in determining whether the first transceiver is within the potential broadcast interference range of the second transceiver.

19. The system of claim 16 wherein the first transceiver transmits a text string identifying the location to the cloud server for use in determining whether the first transceiver is within the potential broadcast interference range of the second transceiver.

20. The system of claim 16 wherein the first transceiver receives the base time from the cloud server.
